(19) United States
(12) Patent Application Publication
(10) Pub. No.: US 2024/0204497 A1
(43) Pub. Date: Jun. 20, 2024

(54) ELECTRIC VEHICLE SUPPLY EQUIPMENT CABLE MANAGEMENT SYSTEM

(71) Applicant: Phillips & Temro Industries Inc., Eden Prairie, MN (US)

(72) Inventors: Andrew Scott ENTER, Edina, MN (US); David HUMENIK, Crystal, MN (US)

(21) Appl. No.: 18/067,228

(22) Filed: Dec. 16, 2022

(51) Int. Cl. H02G 3/04; B60L 53/18

(52) U.S. Cl. CPC H02G 3/0456; B60L 53/18

(57) ABSTRACT

A management system for a charging cable of an electric vehicle charging system includes a mount including a base having a longitudinal axis, a first retainer and a second retainer. The first and second retainers are spaced apart from one another and each include first and second elastically deformable fingers cantilevered from the base. Distal ends of the first and second fingers are spaced apart from the base to define first and second openings positioned transverse relative to the longitudinal axis. The openings are in opposite directions. The management system also includes a strain relief adapted to transfer load from the cable to a structure. A binder clip includes interrupted first and second cylindrical sidewalls. Distal ends of the first sidewall are spaced apart a different distance than distal ends of the second sidewall.

### FIELD

The present disclosure generally relates to equipment for charging an electric vehicle and, more particularly, to a charging cable management system.

### BACKGROUND

This section provides background information related to the present disclosure which is not necessarily prior art.

As electric vehicles are becoming more prevalent, an increased demand for electric vehicle supply equipment (EVSE) exists. Homeowners, business owners and the like are tasked with installing one or more suitable electric vehicle charging stations to supply electrical energy from the grid or a stored energy source to the electric vehicle. The EVSE includes a relatively long charging cable including a first end coupled to the power source and an opposite end including a plug configured to mechanically and electrically connect to a charging input port of the electric vehicle.

The charging cable is typically constructed in accordance with SAE J1772 governing the construction of the connector of the electric cable and the associated conductors within the charging cable. The charging cable may include two power conductors, a ground conductor, a control pilot conductor and a proximity pilot conductor. Accordingly, the outside diameter of the charging cable including insulation and sheathing, is relatively large. The plug end of the cable typically includes a handle and a latch as well as terminals to provide the electrical and mechanical interconnection to the vehicle. The cable and handle combination may have appreciable weight.

Many existing electric vehicle supply equipment charging stations include a housing containing electronic controls for the charging station, a holster for the handle and a bracket about which the charging cable may be wrapped. The charging cable and handle with electrical connector are stored in this position when a vehicle is not being charged. To electrically couple the EVSE to the electric vehicle, a user removes the handle with connector from the holster and unwraps the charging cable from the bracket. The operator extends the charging cable around or along the electric vehicle and couples the connector to the electric vehicle. At this time, the relatively weighty charging cable lies on the ground during vehicle charging. Unfortunately, the relatively large diameter cable provides a significant tripping hazard. Additionally, the charging cable may become dirty or otherwise contaminated while lying on the ground. Other vehicles or equipment may traverse the charging cable as it lies on the ground possibly damaging the conductors therein.

With reference to buildings equipped with EVSE, some installers of EVSE may be tempted to run the charging cable through a conduit or some other raceway. This practice is not recommended due to the relatively large amount of heat that may be generated in the cable during charging. For example, United Laboratories identifies safety standards UL 2594 and UL 2231 to guide EVSE installers on this topic. The charging cable should be exposed to atmosphere.

Accordingly, it may be desirable to provide an electric vehicle supply equipment charging station cable management system which maintains the physical location of the charging cable and connector off the ground in an approved manner.

### SUMMARY

This section provides a general summary of the disclosure, and is not a comprehensive disclosure of its full scope or all of its features.

A management system for a cable of an electric vehicle charging system comprises a mount including a base having a longitudinal axis, a first retainer and a second retainer. The first and second retainers are spaced apart from one another and each include first and second elastically deformable fingers cantilevered from the base. Distal ends of the first and second fingers are spaced apart from the base to define first and second openings positioned transverse relative to the longitudinal axis. The openings are in opposite directions. The management system also includes a strain relief adapted to transfer load from the cable to a structure. A binder clip includes interrupted first and second cylindrical sidewalls. Distal ends of the first sidewall are spaced apart a different distance than distal ends of the second sidewall.

A method of mounting an electrical vehicle charging cable to a structure comprises providing a mount having opposing and axially spaced apart flexible arms cantilevered from a base. The method includes coupling the base to the structure and positioning the cable on the base axially between the flexible arms at an angular orientation 45-90 degrees rotated from an installed position. The method further includes rotating the cable and mount relative to one another to deflect the flexible arms and position the cable beneath the flexible arms and oriented at the installed position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is perspective view depicting an exemplary management system for a cable of an electric vehicle charging system;

FIG. 2 is a perspective view of an alternate mounting configuration;

FIG. 3 is a perspective view of a mount of the management system;

FIG. 4 is another perspective view of the mount depicted in FIG. 3;

FIG. 5 is a side view of the mount depicted in FIG. 3;

FIG. 6 is a view depicting a process of coupling a charging cable to the mount depicted in FIG. 3;

FIG. 7 is a perspective view of a strain relief coupled to a structure;

FIG. 8 is an exploded perspective view of the strain relief depicted in FIG. 7; and

FIG. 9 is a perspective view of a binder clip of the management system.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments will now be described more fully with reference to the accompanying drawings.

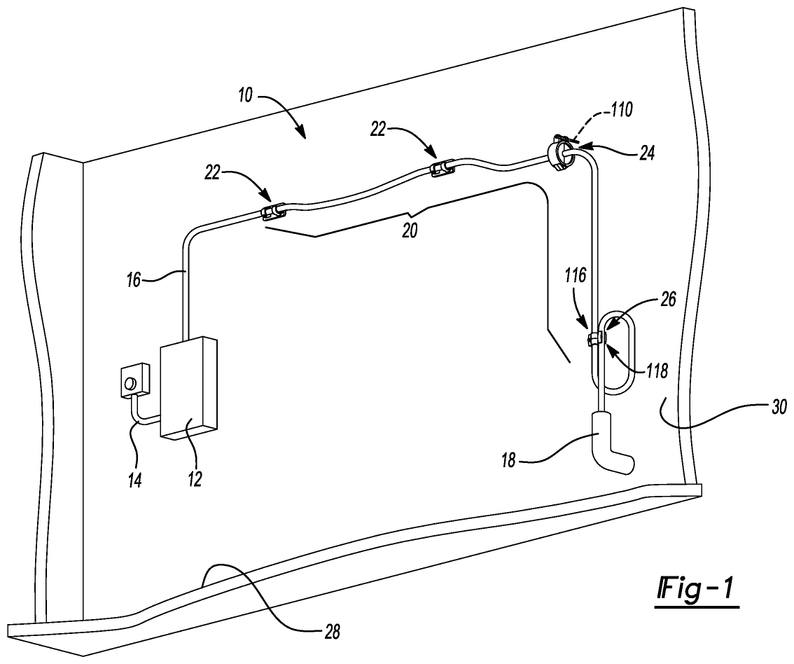

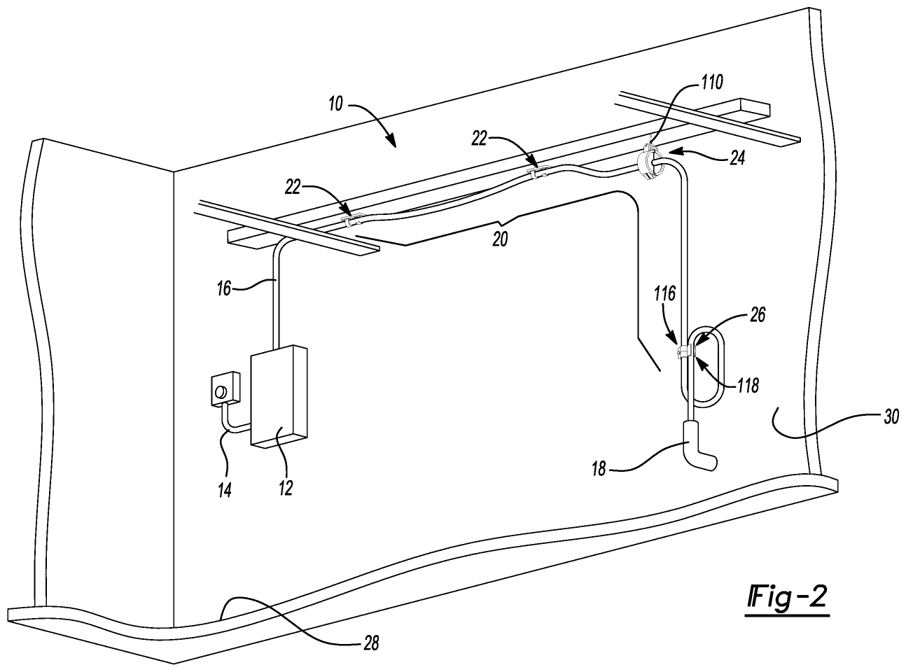

With reference to FIGS. 1 and 2, an exemplary electric vehicle supply equipment 10 includes a charger 12, a power cord 14, a charging cable 16 and a handle 18. Electric vehicle supply equipment 10 further includes a cable management system 20 including one or more mounts 22, a strain relief 24 and binder clip 26. Cable management system 20 functions to couple charging cable 16 to a wall, a ceiling, posts or other structures to maintain the position of charging cable 16 above a ground or floor surface 28. Cable management system 20 also serves to locate handle 18 at a location adjacent a likely parking spot for an electric vehicle requiring charging. It should be appreciated that mounts 22 may be fixed to an exemplary wall 30, as depicted in FIG. 1. The location of mounts 22 may vary based on the length of charging cable 16 and the distance between charger 12 and a desired position for handle 18. It should be appreciated that handle 18 includes electrical terminals adapted to mechanically and electrically couple charging cable 16 and charger 12 to the electric vehicle. FIG. 2 depicts an alternate configuration with mounts 22 and strain relief 24 fixed to ceiling structures.

Strain relief 24 is fixed to wall 30 in the exemplary configuration depicted in FIG. 1. Strain relief 24 may be alternatively fixed to a ceiling as shown in FIG. 2, a post or other suitable structure to react a load that may be imparted by a user tugging on handle 18 or charging cable 16 during use. The weight of handle 18 and the terminal portion of charging cable 16 are supported by strain relief 24 when not in use. The load due to gravity and other loads that may be applied by user during use are transferred through strain relief 24 to the structure to which it is mounted. Strain relief 24 limits the transfer of load further along charging cable 16 such that there is no tendency to remove charging cable 16 from mounts 22.

Binder clip 26 includes a first portion 32 adapted to be fixed to charging cable 16 at a first location along the length of the cable. A second portion 34 of binder clip 26 allows selective and repeated insertion and removal of another portion of charging cable 16 within the second portion of binder clip 26. The user may set the length of a loop of charging cable 16 existing between first portion 32 of binder clip 26 and second portion 34 of binder clip. The length of the loop will define the amount of charging cables 16 extending beyond second portion 34. This procedure will also determine the final hanging position of handle 18. A user of electric vehicle supply equipment 10 may define the attachment point for first portion 32 of binder clip 26 to charging cable 16 to allow a sufficient amount of charging cable 16 to exist between the first portion 32 and handle 18 to account for a range of parking positions of the electric vehicle to be charged. A detailed description of each of the components of cable management system 20 follows.

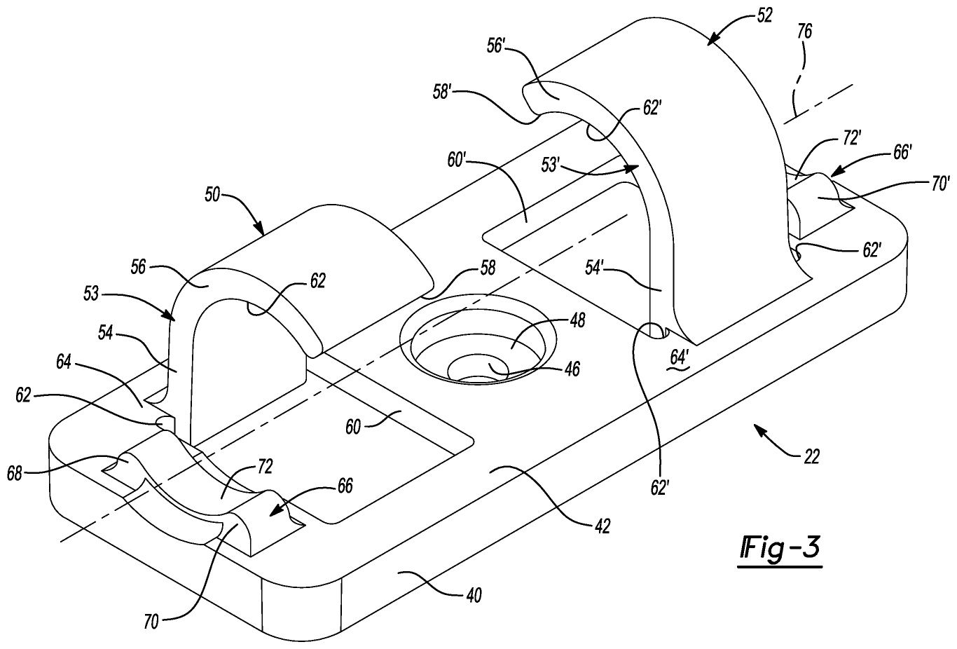

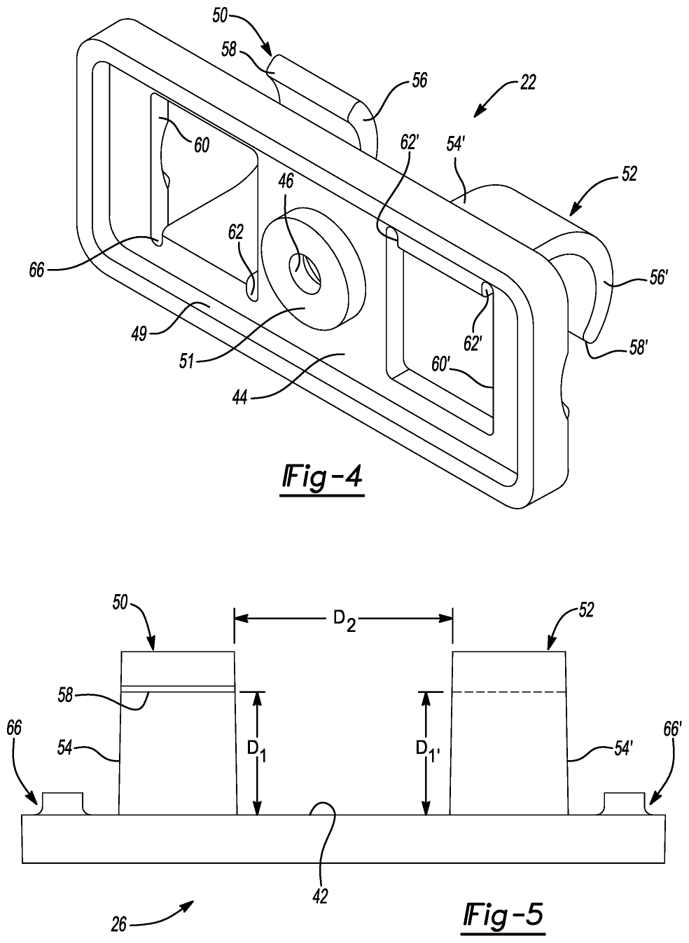

With reference to FIGS. 3-6, mount 22 is a one-piece monolithic structure preferably formed of a plastic material such as acetal. Mount 22 includes a base 40, an upper surface 42 and a lower surface 44. An aperture 46 extends through base 40. A counterbore 48 is sized and shaped to receive a head of a fastener (not shown) used to fix mount 22 to wall 30 or another structure. Preferable, an upper surface of the head of the fastener will be parallel with upper surface 42 or recessed further within counterbore 48 to clear charging cable 16 when coupled to mount 22. A perimeter flange 49 and a mounting boss 51 outwardly extend from lower surface 44 in equal amounts to provide mounting surfaces engageable with wall 30.

Mount 22 includes a first retainer 50 and a second retainer 52. First retainer 50 is substantially similar to second retainer 52 with the retainers being axially spaced apart from and opposing one another. First retainer 50 includes a flexible arm 53 having a wall portion 54 extending substantially perpendicular to base 40 and a curved portion 56 extends from wall portion 54. Flexible arm 53 and curved portion 56 terminate at a distal end 58. An aperture 60 extends through base 40. Aperture 60 includes notches 62 positioned on opposite sides of first retainer 50 to define a zone of reduced material 64 that may act as a hinge when charging cable 16 is coupled to mount 22 causing flexible arm 53 to deflect from its unloaded position depicted in the figures.

Curved portion 56 of the first retainer 50 includes an inner surface 62 having a radius of curvature substantially the same as an outer diameter of charging cable 16. Distal end 58 is spaced apart from upper surface 42 a distance D₁ that is less than the outer diameter of charging cable 16. Preferably distance D₁ ranges between approximately 75% and 90% of the outer diameter of charging cable 16. The spacing will ensure a snap-fit interconnection between charging cable 16 and first retainer 50.

Mount 22 further includes a first cable rest 66 protruding from upper surface 42 of base 40 in the same direction as wall portion 54. First cable rest 66 is shaped as a saddle including a first protrusion 68, a second protrusion 70 and a seat 72 positioned between the first and second protrusions 68, 70. Seat 72 may be shaped as a curved surface having a radius substantially similar to the outer surface of charging cable 16. The position and shape of first cable rest 66 assures that once charging cable is positioned in engagement with inner surface 62 of first retainer 50 and seat 72, movement of charging cable 16 relative to mount 22 is restricted.

Second retainer 52 is substantially similar to first retainer 50. To avoid repetitive description, like elements of second retainer 52 will be identified with the reference numerals of first retainer features including a prime suffix. Mount 22 includes a longitudinal axis 76 extending coaxially with a centerline of charging cable 16 when charging cable 16 is positioned in a fully clipped or seated location within first retainer 50 and second retainer 52. First retainer 50 is axially spaced apart from second retainer 52 a distance D₂. It is contemplated that distance D₂ is at least the diameter of charging cable 16 and preferably 1.5 times the outer diameter of charging cable 16. For clarity, it should be appreciated that distal end 58′ of second retainer 52 is spaced from upper surface 42 a distance D₁′ that is equal to D₁. Both distal end 58 and distal end 58′ extend substantially parallel to longitudinal axis 76. As previously mentioned, this geometrical configuration provides an opening of first retainer 50 that extends in a first direction transversely to longitudinal axis 76 while second retainer 52 defines an opening extending in an opposite direction that is also transverse to longitudinal axis 76.

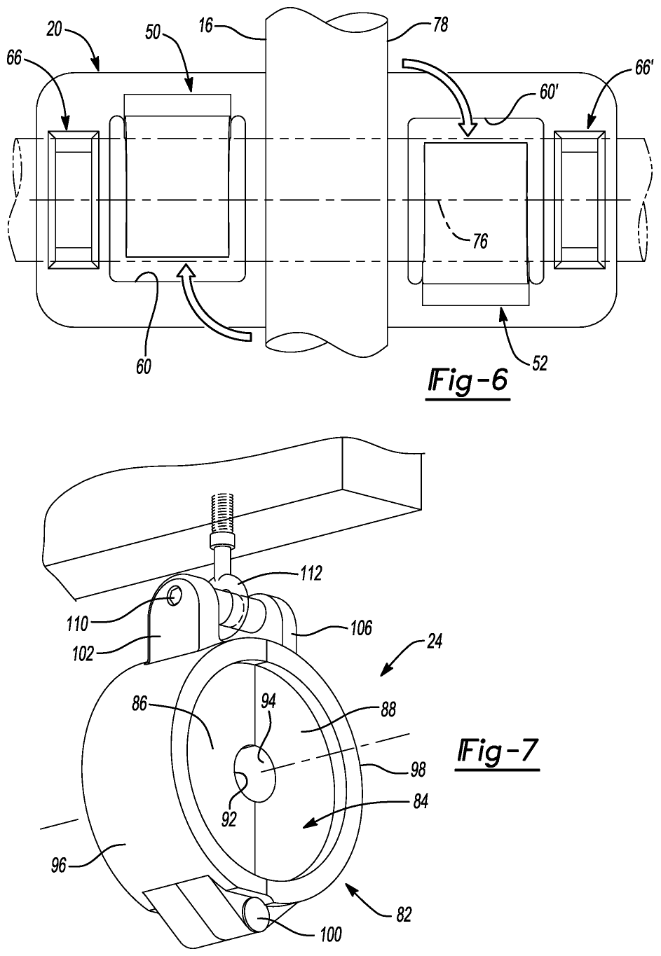

With reference to FIG. 6, a method of coupling charging cable 16 to mount 22 is depicted. In a first step, mount 22 is fixed to a suitable structure, such as wall 30, by a fastener (not shown). The fastener extends through aperture 46 and is affixed to the structure until the head of the fastener drivingly engages the bottom of counterbore 48 and rigidly couples mount 22 to wall 30. In a following step, charging cable 16 is placed in engagement with upper surface 42 and oriented to extend in a generally transverse direction to longitudinal axis 76. It should be appreciated that charging cable 16 need not extend exactly perpendicularly to longitudinal axis 76 but within a range of approximately 45° to 90° to longitudinal axis 76. Subsequently, charging cable 16 is rotated in a direction indicated in FIG. 6 to cause an outer surface 78 of charging cable 16 to engage distal ends 58, 58′ of first retainer 50 and second retainer 52, respectively. A rotating force or torque is continued to be applied to deflect fingers 53, 53′ sufficiently to allow charging cable 16 to engage inner surfaces 62, 62′ while concurrently engaging seat 72 and seat 72′. At the completion of coupling charging cable 16 to mount 22, a longitudinal axis of charging cable 16 is coaxially aligned with, or extends at least substantially parallel to, longitudinal axis 76. This procedure may be repeated as many times as necessary based on the number of mounts 22 installed at the particular charging location.

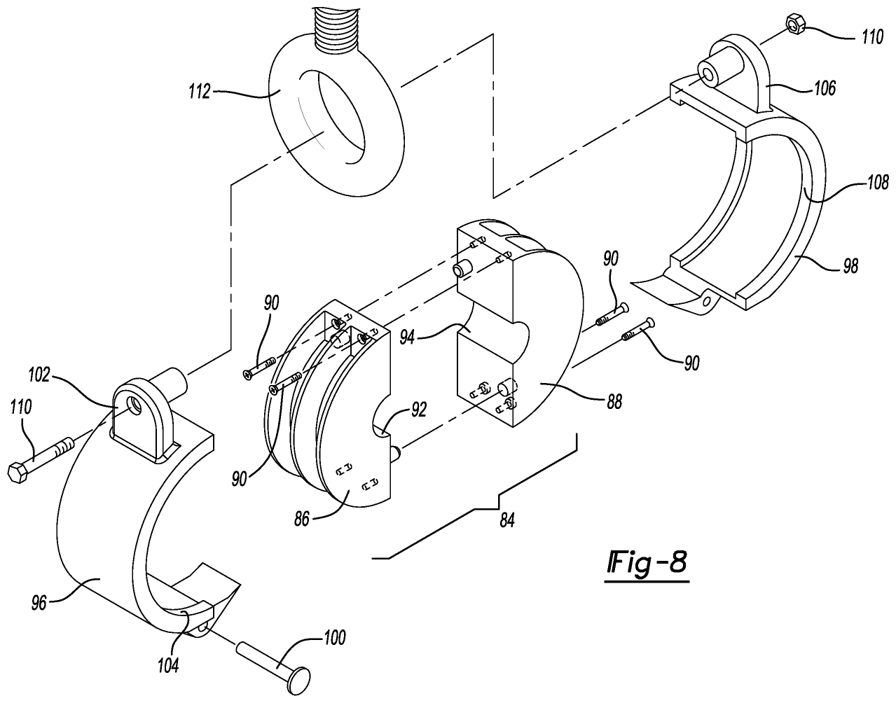

Strain relief 24 is best depicted in FIGS. 7-8. Strain relief 24 includes a clamp assembly 82 circumscribing a puck assembly 84. Puck assembly 84 includes a first half 86, a second half 88 and a plurality of fasteners 90 affix first half 86 to second half 88. First half 86 includes a first semi-cylindrical pocket 92. The second half 88 includes a similar shaped second semi-cylindrical pocket 94 diametrically opposed to first semi-cylindrical pocket 92. When coupled together, first semi-cylindrical pocket 92 and second semi-cylindrical pocket 94 define an aperture sized slightly smaller than an outer diameter of charging cable 16. When first half 86 is separated from second half 88, charging cable 16 is placed within first semi-cylindrical pocket 92 and second semi-cylindrical pocket 94. Fasteners 90 are torqued to affix first half 86 to second half 88 and clamp charging cable 16 therebetween. At this time, charging cable 16 is restricted from movement relative to puck assembly 84.

Clamp assembly 82 includes a first clamp half 96 pivotally coupled to a second clamp half 98 by a pin 100. The first clamp half 96 includes a first ear 102 radially outwardly extending from a semi-cylindrical frame 104. Similarly, second clamp half 98 includes a second ear 106 radially outwardly extending from the second semi-cylindrical frame 108. During installation of strain relief 24, first clamp half 96 is rotated relative to second clamp half 98 to allow insertion of puck assembly 84 therein. First clamp half 96 and second clamp half 98 are substantially rotated relative to one another such that first cylindrical frame 104 engages first half 86 and second semi-cylindrical frame 108 engages second half 88. At this time, first ear 102 abuts or is at least positioned proximate to but spaced apart from second ear 106. Apertures extends through each of first ear 102 and second ear 106 for receipt of a fastener 110 to mount strain relief 24 to wall 30 via another fastener such as an eye-bolt 112. After assembly, load applied to handle 18 will be reacted by strain relief 24 and not mount 22.

Cable management system 20 further includes a binder clip 26 configured to engage charging cable 16 at a first location 116 as depicted in FIG. 1 as well as at a second location 118. At first location 116, it is desirable to rigidly fix binder clip 26 to charging cable 16. The interconnection of binder clip 26 and charging cable 16 at second location 118 is that of repeated connection and disconnection based on handle 18 being in the stored position as depicted in FIG. 1 or in a deployed position when charging an electric vehicle.

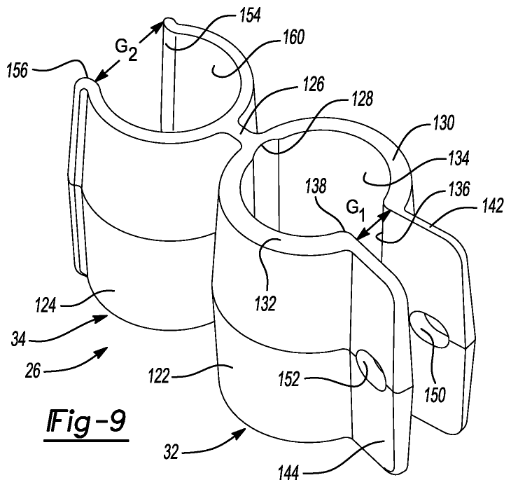

As shown in FIG. 9, binder clip 26 includes an interrupted first cylindrical wall 122 and an interrupted second cylindrical wall 124 interconnected by a web 126. It is contemplated that binder clip 26 is a one-piece monolithic component molded from a plastic material such as acetal or polycarbonate. First cylindrical wall 122 includes a recess 128 locally reducing the thickness of the wall. This geometrical feature acts as a hinge allowing a first portion 130 of first cylindrical wall 122 to move relative to a second portion 132. An inner surface 134 of interrupted first cylindrical wall 122 has a contour substantially similarly shaped and sized to outer surface 78 of charging cable 16. First portion 130 terminates at a first end 136 while second portion 132 terminates at a second end 138. First and second ends 136, 138 are circumferentially spaced apart from one another. A first flange 142 is integrally formed with and radially outwardly extends from first portion 130. Similarly, a second flange 144 is integrally formed with and radially outwardly extends from second portion 132. In an as-molded, unloaded condition as depicted in FIG. 9, first flange 142 diverges from second flange 144. A distance or gap G1 between first end 136 and second end 138 is predefined as approximately 50% to 75% of the outer diameter of outer surface 78. When gap G1 between ends 136, 138 is reduced or eliminated, first flange 142 extends substantially parallel to second flange 144.

During installation of binder clip 26, charging cable 16 is guided between first flange 142 and second flange 144 in a transverse direction relative to interrupted first cylindrical wall 122. First portion 130 is urged away from second portion 132 until charging cable 16 is placed into engagement with or at least positioned proximate to inner surface 134. At this time, an installer urges first flange 142 and second flange 144 toward one another. A mechanical fastener (not shown) is inserted through a first slot 150 of first flange 142 and a second slot 152 of second flange 144 to place a clamping load on charging cable 16 such that relative movement between binder clip 26 and charging cable 16 is restricted.

Interrupted second cylindrical wall 124 includes a first end 154 spaced apart from a second end 156 by a distance G2. G2 is a gap sized at approximately 75% of the outer diameter of outer surface 78 of charging cable 16. The material used for binder clip 26, in combination with the thickness of second cylindrical wall 124, allows repeated elastic movement between first end 154 and second end 156 during installation and removal of charging cable 16 from a position in contact with an inner surface 160 of second cylindrical wall 124. Inner surface 160 is sized and shaped to impart a clamping load on charging cable 16 to secure handle 18 and charging cable 16 at a desired second location 118 on charging cable 16 but the force is of a magnitude allowing a user to repeatedly connect and disconnect binder clip 26 from charging cable 16 at second location 118. Concurrently, first cylindrical wall 122 remains fixed in constant engagement with charging cable 16 at first location 116. It should be appreciated that a user may vary location 118 as desired during subsequent disconnection and connection events.

The electric vehicle supply equipment charging cable management system described provides great versatility to an installer. The number and location of mounts may be varied based on the environment in which the vehicle is to be charged. A desired position of the handle may simply be adjusted through use of the binder clip. An optimized and organized charging station results.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A management system for a charging cable of an electric vehicle charging system, the management system comprising:
a mount including a base having a longitudinal axis, a first retainer and a second retainer spaced apart from the first retainer, the first retainer and the second retainer each including first and second elastically deformable fingers that are cantilevered from the base, a distal first end of the first finger being spaced apart from the base to define a first opening positioned transverse to the longitudinal axis and facing a first side of the base, the second finger including a distal second end spaced from the base to define a second opening positioned transverse to the longitudinal axis and facing a second side of the base opposite the first side, wherein first end of the first finger and the second end of the second finger are spaced apart from the base a predetermined distance adapted to be less than an outer diameter of the charging cable;
a strain relief including an aperture adapted to receive the charging cable, wherein the strain relief is adapted to transfer load from the charging cable through the strain relief to a structure to which the strain relief is mounted; and
a binder clip adapted to be coupled to the charging cable at two spaced apart locations, the binder clip including an interrupted first cylindrical side wall and an interrupted second cylindrical sidewall interconnected by a web, the first cylindrical sidewall having distal ends spaced apart a first distance, the second cylindrical sidewall having distal ends spaced apart a second distance greater than the first distance.

2. The management system of claim 1, wherein the first finger includes a first curved wall and the second finger includes a second curved wall that are coaxially aligned along the longitudinal axis.

3. The management system of claim 1, wherein the base includes a first aperture extending therethrough and aligned with the first finger as well as a second aperture extending through the base and aligned with the second finger.

4. The management system of claim 3, wherein the mount includes a first cable rest positioned adjacent the aperture aligned with the first finger and a second cable rest positioned adjacent the aperture aligned with the second finger, wherein the first and second cable rests are adapted to directly engage the charging cable when it is coupled to the mount.

5. The management system of claim 5, wherein each of the cable rests includes a curved seat.

6. The management system of claim 1, wherein the base of the mount includes a fastener aperture extending therethrough, the fastener aperture being longitudinally positioned between the first retainer and the second retainer.

7. The management system of claim 1, wherein the mount and the strain relief and the binder clip are spaced apart from one another.

8. The management system of claim 1, wherein the mount is adapted to retain the charging cable in a position axially aligned with the longitudinal axis by placing the charging cable on the base and rotating the charging cable and the base relative to one another to cause the charging cable to pass through the first opening and the second opening while elastically deflecting the first finger and the second finger.

9. The management system of claim 1, wherein the first finger is longitudinally spaced from the second finger a distance more than a diameter of the charging cable to be coupled.

10. A method of mounting an electric vehicle charging cable to a structure, the method comprising:
providing a mount having opposing and axially spaced apart flexible arms cantilevered from a base;
coupling the base to the structure;
positioning the charging cable on the base axially between the flexible arms at an angular orientation 45-90 degrees rotated from an installed position; and
rotating the charging cable and mount relative to one another to deflect the flexible arms and position the cable beneath the flexible arms at the installed position.

11. The method of claim 10, further comprising coupling a first portion of the charging cable to a binder clip spaced apart from the mount.

12. The method of claim 11, further comprising removably coupling a second portion of the charging cable to the binder clip.

13. The method of claim 12, wherein coupling the first portion of the charging cable to the binder clip includes elastically urging ends of an interrupted first wall away from one another and subsequently fixing the ends to one another.

14. The method of claim 13, wherein coupling the second portion of the charging cable to the binder clip includes elastically urging ends of an interrupted second wall away from one another.

15. The method of claim 14, wherein, the first wall and second wall are interconnected by a web.

16. The method of claim 10, further comprising setting a position of a distal end of the charging cable relative to the structure by fixing a first portion of the charging cable to a binder clip and subsequently removably coupling a second portion of the charging cable to the binder clip, wherein the binder clip is not attached to the structure.

17. The method of claim 10, further comprising fixing the charging cable to a strain relief that is fixed to the structure.
